(19) United States
(12) Patent Application Publication
(10) Pub. No.: US 2023/0120304 A1
(43) Pub. Date: Apr. 20, 2023

(54) DISPENSER, POD, AND METHOD FOR DISPENSING AND TRACKING USAGE OF SUPPLEMENTS AND/OR PHARMACEUTICALS

(71) Applicant: TESPO IP, LLC, Plymouth, MI (US)

(72) Inventors: Justin Michael GAUVIN, Waltham, MA (US); Ted Matthew MILLS, Novi, MI (US); Chase Ryan LINTON, Ann Arbor, MI (US); Jeffrey Thomas LINTON, Ann Arbor, MI (US)

(73) Assignee: TESPO IP, LLC, Plymouth, MI (US)

(21) Appl. No.: 17/912,814

(22) PCT Filed: Mar. 20, 2021
(86) PCT No.: PCT/US2021/023363

§ 371 Date: Sep. 19, 2022

Related U.S. Application Data
(60) Provisional application No. 62/992,482, filed on Mar. 20, 2020.

(51) Int. Cl. B65D 83/04; A61J 7/00; G07F 17/00

(52) U.S. Cl. CPC B65D 83/0454; A61J 7/0084; G07F 17/0092; A61J 2205/10; A61J 2205/30; A61J 2205/60; A61J 2200/74; A61J 2200/30

(57) ABSTRACT

A multi-serving cartridge assembly is provided with a frame defining serving chambers to receive a supplement. A plurality of trap doors is connected to the frame with each trap door associated with a respective one of the plurality of serving chambers and moveable between a first closed position to enclose the associated serving chamber and a second open position to dispense the supplement therefrom. A dispensing system is provided with a housing including a cartridge bay shaped to receive a cartridge with a plurality of unique identifiers, and a computer control system to read the unique identifier, open the serving chamber, and send a signal to a remote system. A method of dispensing supplement from a cartridge is also provided.

### CROSS-REFERENCE TO RELATED APPLICATIONS

This application claims the benefit of U.S. provisional application Ser. No. 62/992,482 filed Mar. 20, 2020, the disclosure of which is hereby incorporated in its entirety by reference herein.

### TECHNICAL FIELD

Various embodiments generally relate to a system and method for the connected adherence tracking and delivery of supplements and/or pharmaceuticals in measured doses to be dispensed, administered, then consumed directly or consumed after mixing with a liquid or other substance.

### BACKGROUND

Conventionally, consumers have supplements that are packaged in bulk in bottles, cans, or other containers. As such, the consumer has to remember the quantity and time that they would like to take the supplement. This may become more complicated for consumers that are taking multiple supplements simultaneously, as they may have different dosage or timing requirements associated with each supplement. This may also result in a consumer over-dosing or under-dosing. Additionally, for a consumer that is ill, managing supplements may become complicated and difficult.

Pill boxes and the like have been developed to help organize pill consumption for people, but require a high degree of discipline to use regularly, and also require the person to manually fill the pill box with supplements on a regular basis as well as recall when to take the supplement.

### SUMMARY

In an embodiment, a multi-serving cartridge assembly has a frame having sidewalls extending axially to define a plurality of serving chambers arranged in an annular array centered about a central axis. The frame has a first side defining a plurality of chamber openings, with each chamber opening associated with a respective one of the serving chambers. The frame has a second closed side opposite to the first side, with each serving chamber sized to receive a supplement. A drive hub is supported by the frame, and the drive hub interfaces with a drive mechanism of a dispensing apparatus. A plurality of trap doors is provided and each trap door is associated with a respective one of the plurality of serving chambers. Each trap door is connected to the frame for movement relative thereto between a first closed position to enclose the associated serving chamber and a second open position to dispense the supplement therefrom, with each trap door being separably openable.

In another embodiment, a dispensing system has a housing including a cartridge bay shaped to receive a generally annular cartridge for rotation about a central axis, with the generally annular cartridge centered about the central axis and including a plurality of serving chambers to receive supplement in each serving chamber and a plurality of unique identifiers. Each unique identifier is associated with a respective one of the serving chambers to identify and provide information regarding each serving chamber. An actuator system is supported by the housing and has a member to engage the cartridge to selectively open one of the serving chambers and empty the supplement therefrom. A cartridge drive mechanism is provided for rotating the cartridge about the central axis within the cartridge bay. The cartridge drive mechanism has a motor to engage and rotate the cartridge when the cartridge is disposed in the cartridge bay. A sensor is supported by the housing adjacent to the cartridge bay, with the sensor positioned to read one of the unique identifiers. A computer control system is operatively connected to the cartridge drive mechanism to (i) rotationally index the cartridge in the cartridge bay until an unopened serving chamber is located directly adjacent the actuator system, (ii) read the unique identifier associated with the unopened serving chamber, (iii) control the member to open the serving chamber, and (iv) send a signal to a remote system with the information regarding the associated serving chamber.

In yet another embodiment, a method of dispensing supplement from a cartridge is provided. A unique identifier associated with a serving chamber of a cartridge that provides information regarding supplement within the serving chamber is sensed, with the cartridge having a plurality of serving chambers to receive a volume of supplement in each serving chamber and a plurality of unique identifiers. A user is verified based on sensed personal identification information associated with a user of the cartridge. A signal is sent to a remote viewing device to overlay the information from the unique identifier as part of a virtual reality or an augmented reality. Another signal is sent to a remote system with the information from the unique identifier. Information from the remote system is received with updated dosing information for a user determined as a function of the unique identifier, and at least one of an input from a medical professional, a health record, and personal information of a user. Supplement is dispensed from the cartridge by opening one or more of the serving chambers based on the updated dosing information via an actuator system with a member to engage the cartridge to selectively open one of the serving chambers. A dispensed supplement that has been consumed by a user is sensed.

### BRIEF DESCRIPTION OF THE DRAWINGS

FIGS. 1 and 2 illustrate an exploded perspective view and an exploded side view of a pod and cap according to an embodiment;

FIG. 3 illustrates a side sectional view of the pod of FIG. 1;

FIGS. 4, 5, and 6 illustrates a side view, a top perspective view, and a top view of the pod and cap of FIG. 1;

FIG. 7 illustrates a top perspective view of the pod of FIG. 1;

FIG. 8 illustrates a schematic of a pod with different trap door arrangements according to an embodiment;

FIG. 9 illustrates a pod configured to dispense liquid according to the disclosure;

FIG. 10 illustrates an exploded view of a pod according to an embodiment;

FIGS. 11 and 12 illustrate perspective views of a pod with different supplement contained within different serving chambers;

FIG. 13 illustrates a side sectional view of a pod with a partition according to an embodiment;

FIG. 14 illustrates a side sectional view of a pod with a partition according to another embodiment;

FIG. 15 illustrates a perspective view of a pod assembled from serving chamber units according to an embodiment;

FIG. 16 illustrates a perspective view of a pod assembled from serving chamber units according to another embodiment;

FIG. 17 illustrates a side sectional view of a pod according to an embodiment;

FIG. 18 illustrates a bottom view of a frame of the pod of FIG. 17;

FIGS. 19 and 20 illustrate a bottom view and a perspective view of the pod of FIG. 17 with a single trap door;

FIGS. 21 and 22 illustrate a perspective view and a top view of the pod of FIG. 17 with a cap;

FIG. 23 illustrates a side sectional view of a pod according to another embodiment;

FIG. 24 illustrates a side sectional view of a pod according to an embodiment;

FIGS. 25 and 26 illustrate a top perspective view and a bottom perspective view of a pod accord to another embodiment;

FIGS. 27 and 28 illustrate top schematic views of pods according to an embodiment;

FIG. 29 illustrates a dispensing apparatus with a sensor according to an embodiment;

FIGS. 30 and 31 illustrate perspective views of pods according to another embodiment;

FIG. 32 illustrates a pod containing different supplements in different chambers according to an embodiment;

FIGS. 33 and 34 illustrate a bottom perspective view and a top perspective view of an opening mechanism for a dispensing machine according to an embodiment;

FIGS. 35, 36, and 37 illustrate a partial bottom perspective view, a partial side sectional view, and a bottom perspective view of a pod according to an embodiment;

FIG. 38 illustrates a schematic of an integrated system using the dispensing apparatus and/or pod according to the present disclosure;

FIG. 39 illustrates a schematic illustrating an integrated system between an object, a dispensing apparatus and/or pod, and an augmented, mixed and/or virtual reality system;

FIG. 40 illustrates a dispensing system for use with the pods according to the present disclosure; and

FIG. 41 illustrates another dispensing system for use with the pods according to the present disclosure.

### DETAILED DESCRIPTION

As required, detailed embodiments of the present disclosure are provided herein; however, it is to be understood that the disclosed embodiments are merely examples and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The invention relates generally to a system and method for the delivery of supplements, and also may provide connected adherence, tracking, customization, and guidance for the delivery or dosing of supplements.

As used herein, supplement may refer to a pharmaceutical, a dietary formula, a nutritional supplement, another edible, or any combination thereof. As used herein, supplement and formula or formulas are interchangeable. For example, a supplement may include a pill, a capsule, a caplet, a custom-formulated powder-form, a granulated and/or oil form, a beadlet-form, a liquid dietary formulas, and/or other pharmaceuticals or supplements in measured doses or any other ingestible material that may be fit into the serving chamber. Both terms are intended to broadly define any and all types of nutraceuticals, vitamins, minerals, fibers, fatty acids, proteins, amino acids, effervescents, herbal medicines, bodybuilding formulas, pharmaceuticals, therapeutics, medicines, pet products, drugs, treatments and any other like substance that is ingested or non-ingested for useful purposes. Formulas is also intended to broadly include foods for humans, animals and plants.

Various embodiments according to the present disclosure may be used with systems such as a granulated nutritional supplement dispensing machine configured to extract single-serving doses from a multi-serving supplements cartridge for delivery as a drinkable solution, published as PCT Patent Publication No. WO 2015/073402, on May 24, 2015, the entire disclosure of which is incorporated by reference herein. This dispensing machine utilizes a multi-celled supplements cartridge that is automatically indexed so that an unused serving chamber is presented each time for extracting its supplements. Upon command, a lead serving chamber is opened or pierced so that its contents empty, for example, into a mixing cup. The machine may optionally add a metered quantity of liquid from an integrated liquid tank to the supplement. A vibrator unit assists drainage of the supplement materials from the lead serving chamber. The mixing cup may be spun on an inclined turntable to blend the liquid and supplements into a slurry.

Various embodiments according to the present disclosure may additionally or alternatively work with a portable dispensing lid to enable manual extraction of nutritional supplements from the cartridge for travel applications, or using methods or systems as described in PCT Patent Publication No. WO 2016/126904, published Aug. 11, 2016, the entire disclosure of which is incorporated by reference herein.

There is a need in the art for a more advanced cartridge system for the dispensing of dietary supplements that is amenable to a broadened range of supplement compositions and states (e.g., powders, granules, beadlets/pellets, tablets, pills, liquids, etc.). The improved cartridge system must be conducive to serving-to-serving variability but yet not be susceptible to cross-contamination. The improved cartridge system should easily accommodate segregation of certain components, for long-term storage or for ill-suited for long-term commingled storage but that nevertheless are intended for concurrent consumption in a single dose. Furthermore, and depending on the supplement used, the improved cartridge system may need to be easy to evacuate or empty. Also, the cartridge system may need to be air-tight, liquid tight, and/or hermetically-sealable, and may be configured to enable convenient re-use, re-filling, and/or recycling.

According to various embodiments of the present disclosure, the pod cartridge system is configured to dispense a broad range of supplements. The cartridge can easily accommodate a variety of supplement compositions and states (e.g., powders, granules, beadlets/pellets, tablets, pills, capsules, liquids, etc.). The cartridge system is conducive to serving-to-serving variability while avoiding or minimizing the possibility of cross-contamination. Higher concentration doses can be administered for daytime consumption and lower concentration doses for nighttime consumption as but one example of many possibilities. The cartridge system of the present disclosure may be adapted to segregate certain components that are ill-suited for long-term comingled storage but that nevertheless are intended for concurrent consumption in a single dose. For one example, non-mixable supplement ingredients can be contained in a separate cell or compartment from other ingredients but dispensed simultaneously or in rapid succession. Furthermore, the cartridge system of this disclosure may be designed to be easy to evacuate or empty. And still further, the cartridge system may be designed to hermetically-seal the supplements until the time of dispensing. The cartridge may be also reuseable and/or recyclable.

Referring to the figures, like numerals indicate like or corresponding parts throughout the various views, and a cartridge system, or pod, is generally shown at 20 throughout the views in various embodiments or configurations.

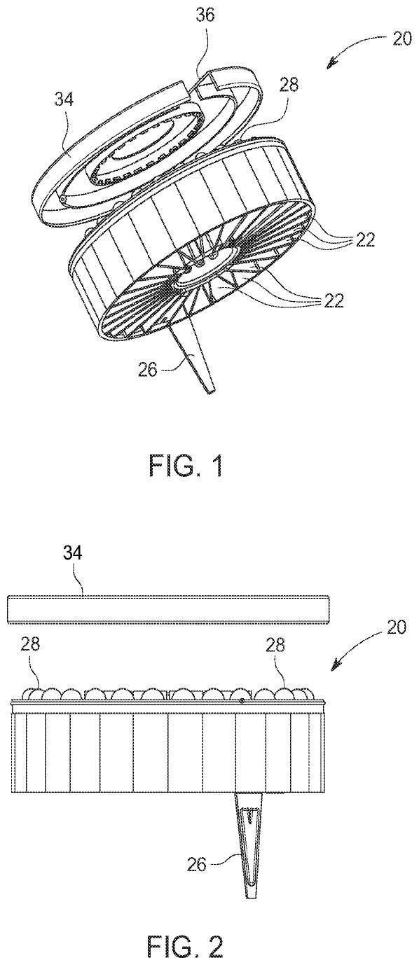

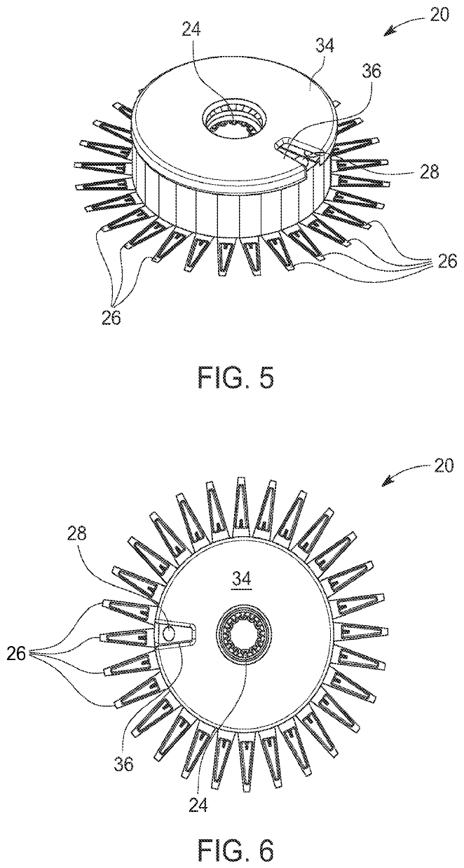

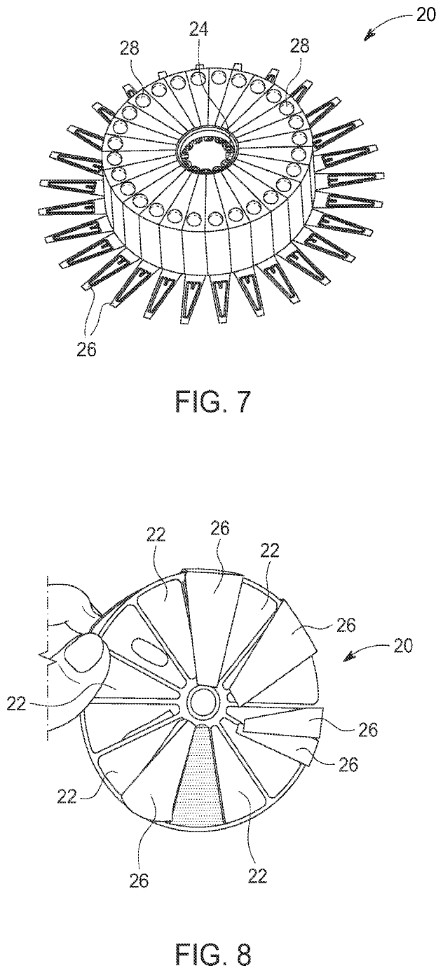

According to one example, and as shown in FIGS. 1-7, the pod 20 has multiple serving chambers 22 arranged in an annular array to accommodate rotary indexing from one serving chamber 22 to the next. In the illustrated examples, all of the serving chambers 22 in the pod 20 are of identical size and shape. Each has a truncated sector-shape radiating from a central drive hub 24. In other examples, the pod 20 may have any number of chambers, such as one chamber, two chambers, seven chambers, thirty chambers, or any other number of chambers or with chambers of various sizes and/or shapes. For example, a pod having one hundred or more chambers is contemplated.

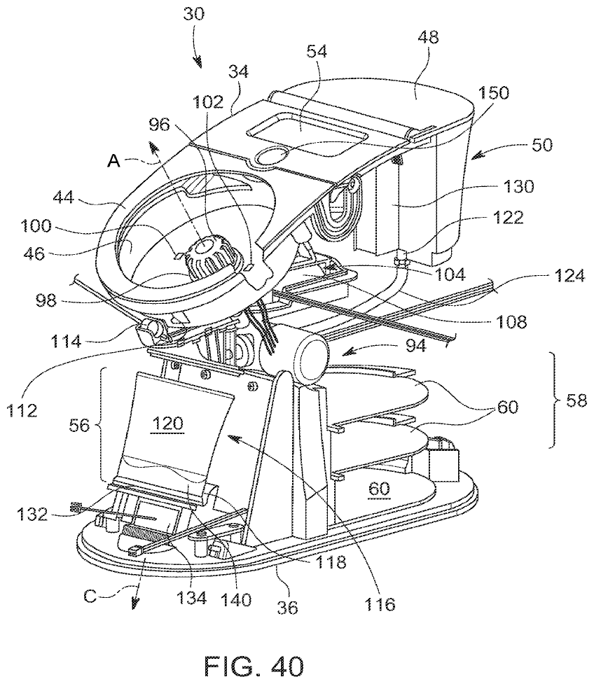

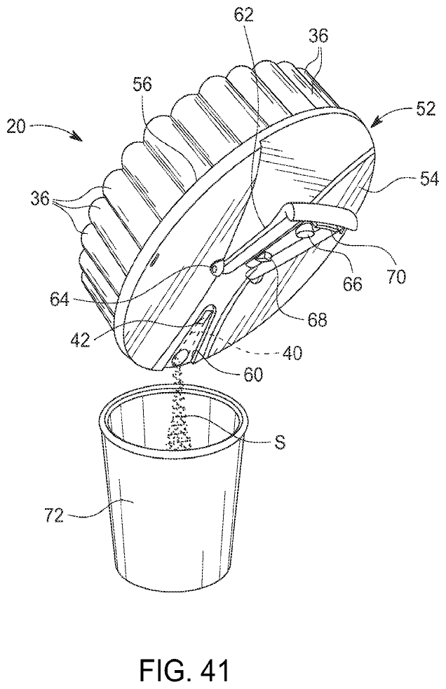

The drive hub 24 is adapted to interface with a rotary drive shaft of a dispensing machine, such as that shown in FIGS. 40-41 and described in PCT Patent Publication Nos. WO 2015/073402 and WO 2016/126904. However, in some contemplated embodiments the serving chambers 22 are of unequal size/shape and in some embodiments the central drive hub 24 is omitted in favor or an external/circumferential drive interface. In other examples, the central drive hub may become a pass-through hole central drive hub with the spline teeth.

Any number of serving chambers 22 are designed for universal use, filled, partially filled or not filled, in terms of the types and forms of supplements that can be dispensed from each chamber. For example, the supplements could be of any one or more of the following types: pharmaceuticals, active ingredients, flavoring, special agents, pet products, plant products, effervescent, candy pieces, baking ingredients, foods (e.g., teas and spices), and so forth. In terms of form, the supplements capable of use in the pod 20 include, but are not limited to: liquids, powders, granules, beadlets/pellets, oils, pills (including tablets and gel capsules), and the like. It must be understood that the forms and types of supplements mentioned here are for purposes of illustration only, and are not intended to represent exhaustive lists. The top of each serving chamber 22 is closed (or capable of being sealed closed).

Each pod 20 has multiple individual air-tight (i.e., hermetic) serving chambers 22. Each serving chamber 22 has an open bottom that is associated with a trap door 26, or other form of closure device, that when triggered is pushed or moved from its original position to open the air tight serving chamber 22 so that consumable contents contained therein will be evacuated. In most of the examples provided by way of the accompanying illustrations, the trap door 24 is depicted as being connected via a hinge (e.g., an integral or “living” hinge) to the radially outermost edge of the serving chamber 22 bottom. The hinge could alternatively adjoin one of the radial edges so that the trap door 26 opens to the side or as a hinge from the center of the associated chamber 22 closest to the central hub. The trap door 26 could alternatively be on a sliding track or an iris action mechanism, such that the door opens by sliding to the side or towards the outermost radial edges.

An actuator system may be used to manipulate the trap door 26. (Some contemplated embodiments of this invention omit a remote actuator in favor of direct actuation of the trap door 26, such as with a small protruding lip or the like). The actuator system can take many different forms, which include but are not limited to a push-rod mechanism to move the trap door, a mechanism that engages an outer edge or lip of the trap door, or the like. The actuator system may be incorporated into a motorized or automatic dispensing system. Alternatively, the actuator system may be incorporated into a manual or travel, or portable dispensing system. The actuator system is used to open and/or close the trap door.

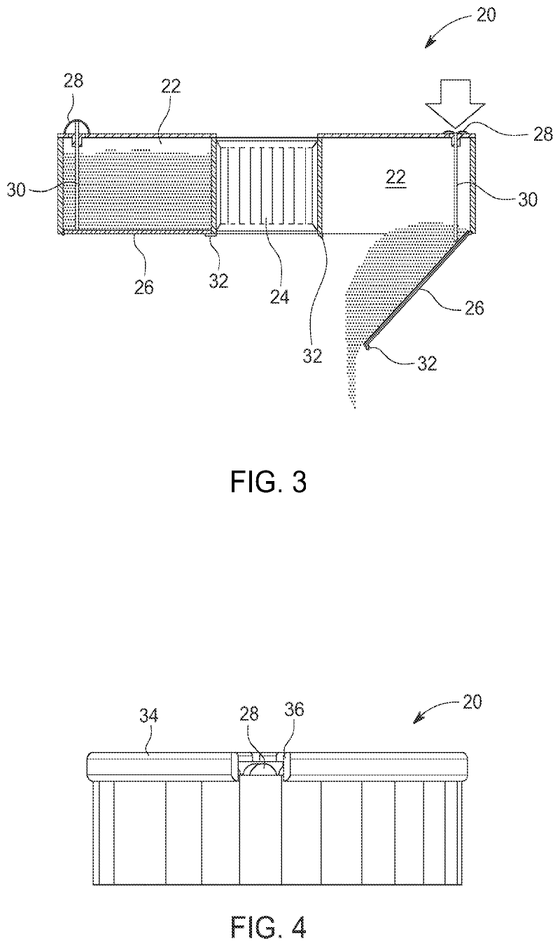

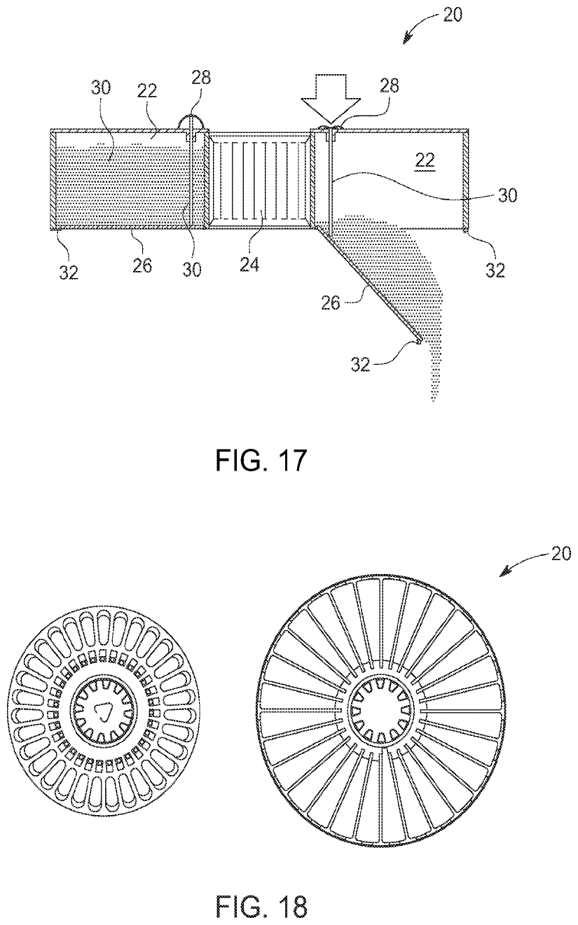

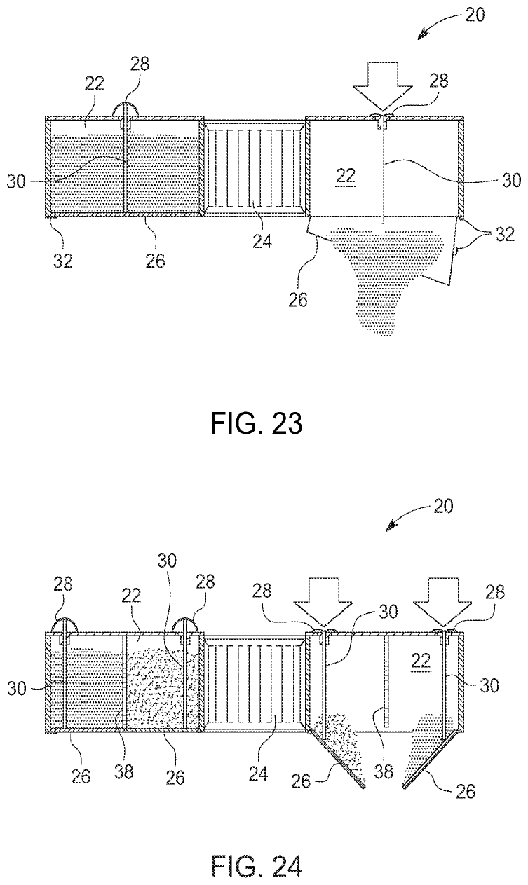

In one example, the actuator system includes a pushrod mechanism is shown in one very simplified form in the cross-sectional view of FIG. 3. A flexible, bubble-like trigger 28 is located on the top of each serving changer near its radially outermost edge in the case of a trap door 26 that is hinged along the radially outermost edge of the serving chamber 22. The trigger 28 covers a push-rod 30 that extends through the serving chamber 22 and abuts against the trap door 26. The location of the trigger 26 and push rod 30 are coordinated with the location of the trap door 26 hinge or other opening strategy. In some contemplated embodiments, the trigger 28 is located at or near the drive hub 24 as shown in FIG. 17. In other embodiments, the trigger 28 is located at mid-span as shown in FIG. 23.

When a force is applied to the trigger 28, such as by a feature of a travel cap, by a hand tool, by a human finger, or from the actuator of an automated dispensing machine, the push-rod 30 is displaced and presses against the trap door 26 causing the trap door 26 to swing open. In other examples, the actuator or push-rod 30 may be used to twist, slide, snap, hinge, poppet, shift, or otherwise engage the trap door 26 to open it. Following evacuation of the supplements, the trap door 26 can be returned to its staring position to re-close a now-empty serving chamber 22. By re-closing (i.e., re-sealing) the trap door 26, supplements residue left inside the serving chamber 22 will not cross-contaminate subsequent doses.

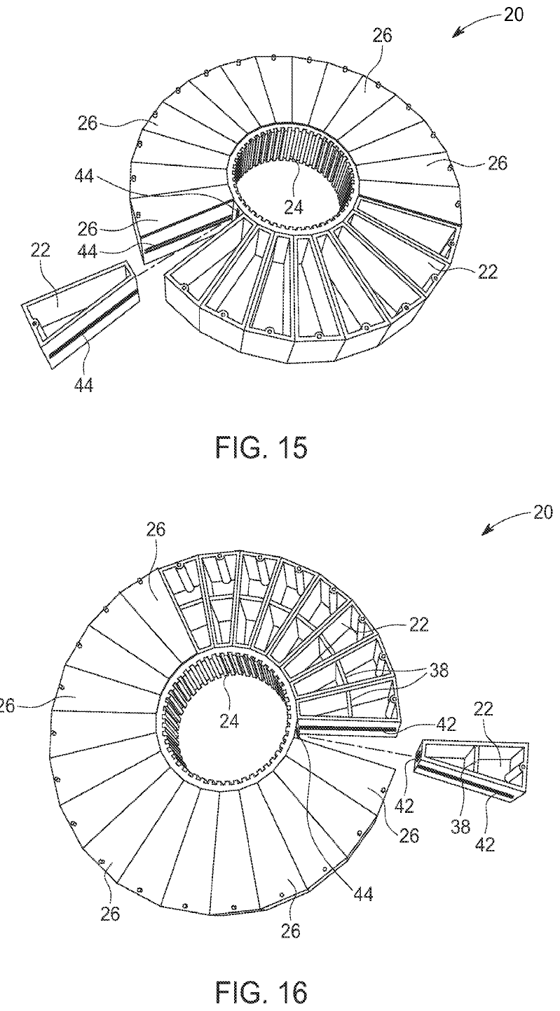

Many alternatives to the bubble-like trigger 28 are possible. In another configuration envisioned by the inventors, the remote actuator could press through the plastic or puncture the plastic to push the internal rod 30 to open the trap door 26. This internal rod may be in its own area or shaft inside the serving chamber 22 as shown in FIGS. 15-16, or alternatively it may be on the outside (external) of the pod outside of the serving chamber 22 but still able to activate or open the trap door 26. The push-rod 30 is depicted in FIG. 3 as a simple straight rigid rod, however those of skilled in the art will appreciate that the push-rod could be reconfigured in a different shape, including but not limited to a cylinder, a tube, a box, a slide, a flexible motion-transmitter, a spring, guide or any other suitable form. The push-rod 30 is shown as a separate element from the trap door 26, however these features could be integrated, and an all-in-one (monolithic material) component. Similarly, the push-rod 30 and dome-like trigger 28 are shown as separate elements from the serving chamber 22, but it is also possible to design these as integrated components.

Thus, each serving chamber 22 could have a rod or slide that activates and opens a compartment to evacuate contents. This rod would be slightly taller than the serving chamber 22 itself. This rod could be encased in the closed compartment or separated into its own chamber to then be attached to a door or these rods could be spring loaded to open the door and retract to close the door. In the simplest of cases, the remote actuator system could be a slight lip on the swinging edge of the trap door 26 that a user could actuate with their fingernail or travel lid or pod/hand tool. In yet another contemplated variation, the push rod is a permanent feature of the dispensing machine, such that a probe-like dispenser rod is configured to push through a cavity in the serving chamber 22 to actuate the trap door 26 or perhaps an intermediary push rod 30 in the pod 20.

The fit between the trap door 26 and the bottom of the serving chamber 22 can take many direct forms to accommodate the particular sealing needs. A well-designed friction fit may be suitable for most applications. The seal could be enhanced with elastomeric edging. Or, a bead-and-groove mechanical fit can be used for a more secure snap/lock connection. FIG. 3 suggests use of a breakable seal tape 32 covering the seam of the trap door 26. Seal tape 32 has the added benefit of indicating breach for safety concerns. Other strategies to maintain a suitable seal between trap door 26 and the bottom of the serving chamber 22 are certainly possible. Furthermore, the bottom opening of the serving chamber 22 and/or the trap door 26 may be specially configured for the particular attributes of supplements to be evacuated from the serving chamber 22, considering size and flow characteristics, etc. That is to say, the shape of the trap door 26 and/or bottom opening of the serving chambers 22 might be designed differently for dispensing pills versus powders or versus liquids, etc. The trap door 26 could thus have a funnel-like shape on its inside (i.e., hidden from view when the serving chamber 22 is closed). However, when the trap door 26 is opened, the funnel-like shape would direct the compartment contents downward with gravity to flow into an underlying cup (not shown). These factors also naturally influence the strategy employed to maintain a suitable seal between trap door 26 and the bottom of the serving chamber 22.

Instead of being hinged, the remote actuator could be designed to interface with the center of the trap door 26 like a poppet. When the trigger is pressed, the trap door 26 shifts down, thus exposing all side edges allowing the supplements to rapidly evacuate. Examples of this type of system may be observed in U.S. Pat. Nos. 8,453,834 and 8,613,372, the entire disclosures of which are hereby incorporated by reference.

Other actuation strategies include: screw-mechanisms in which the trap door 26 is cranked open; foil coverings which are punctured, perforated plastic or foil to be torn or punctured, heating through with wire to melt plastic to create a used serving chamber 22 hole, rotating openings, sliding door, and the like. Each serving chamber 22 could be activated (e.g., by piercing, pressing, peeling, popping, sliding, tearing, etc.) from the drive hub 24 or other region near its inner ring, from its outer ring, from a side wall, from the center, or the other. All such alternative examples are intended to be included within the broad definition of a remote actuator system and of a trap door 26.

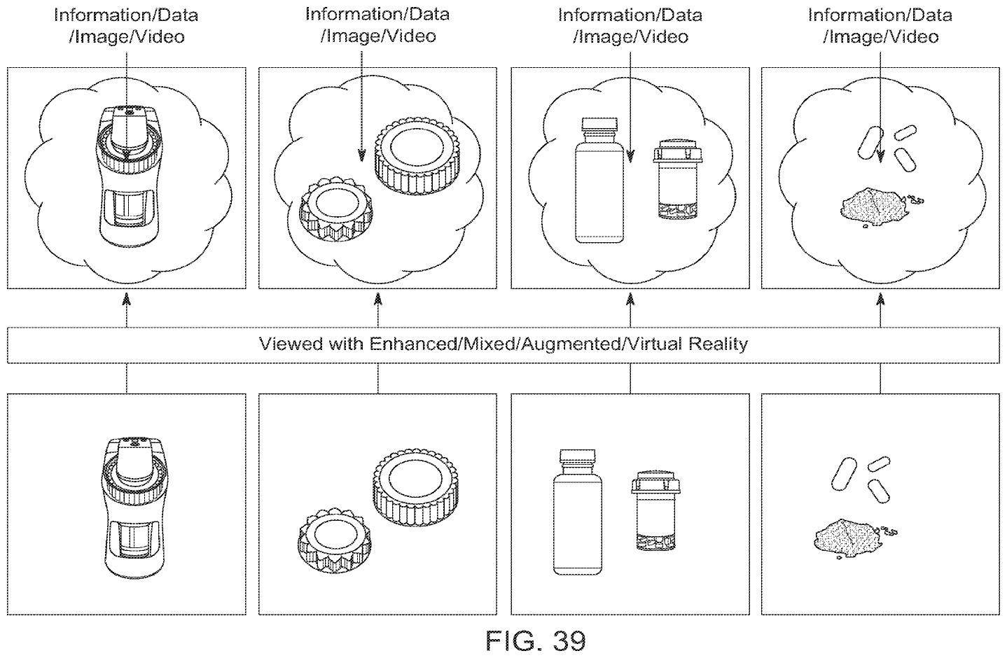

Any number of chambers 22 is fitted with a unique identifier, in the form of a QR code, a barcode, RFID, NFC, beacon, transmitter, sticker, codex, script, electrical strip, a microchip, printed circuit board assembly (PCBA), magnet or the like. The purpose of the unique identifier is to be able to identify and provide information regarding both the contents of each serving chamber 22 whether it has been used or unused and the relative position of each serving chamber 22 within the pod 20. The unique identifier may additionally, provide information to the user or a third party such as a pharmacist, doctor or other medical professional, counselor, advisor, health care provider, insurance provider, home health care worker or aide, family member, patient, business, web or internet application, mobile application, other remote or wireless server or system, and the like. The dispensing system may incorporate or communicate using the unique identifier with viewing technology, scanning technology, augmented reality visuals, points in the supply chain, an ERP system, a CRM system, and the like. The dispensing system may additionally communicate remotely or wirelessly with various supplement management, reordering, or other systems using the unique identifier and additional information. FIG. 39 is a schematic illustrating an integrated system between an object, a dispensing apparatus and/or pod, and an augmented, mixed and/or virtual reality system. The object may be provided with a unique identifier with information such as that related to the type, shape, color, and/or size of a pill; the type, shape, color, and/or size of a powder serving; a pill bottle shape; a label; supplement chemical compositions; instructions for consumption or dosing; and the like. The unique identifier and/or recognition of a known, programmed object may be used to provide digitally displayed (e.g. via augmented, virtual and/or mixed reality) information or data, and this information or data may include visual outputs, audio outputs, images, videos, video conferencing, telehealth, messaging services, or other messages or forms of media, which may be overlaid or otherwise provided onto a surface in the user's field of view. In one example, the information or data is provided using augmented, virtual and/or mixed reality devices, such as glasses, contact lens, mobile devices, cameras, wearable devices, viewing devices, and the like. In other examples, the information or data may be provided onto a wall, ceiling, floor, another object, furniture, appliance, or onto specific objects on these surfaces (e.g. a dispenser, pill container, the actual pill, the pod or another object), and the information or data may be provided as overlay, or other form of media as described above. The system may send, receive, and/or additional information to the user or another individual or entity, for example, in real-time, based on unique identifiers and/or recognition of a known programmed object. The unique identifiers and/or recognition of a known programmed object may be digitally displayed continuously, when the user triggers the unique identifier from an action, when the unique identifier is in the proximity of the user, and/or remotely when the unique identifier is a longer distance away.

By generating the unique identifiers, each individual serving chamber 22 of a multi-chamber pod 20 can be read by a dispenser apparatus and/or by a user. In this manner, the pod 20 can accommodate a variety of formula compositions and states, and is conducive to serving-to-serving variability. For example, some of the serving chambers 22 could be filled with 600 mg of a daytime-intended supplement whereas other serving chambers are filled with 200 mg of a nighttime-intended supplement. Using the unique identifiers, the dispensing machine or user can select one of the high concentration supplement serving chambers 22 for a morning dose, and one of the low concentration supplement serving chambers 22 for an evening dose. This, of course, is but one example of many possibilities afforded by the use of unique identifiers. Other examples include use of the unique identifiers by a health care professional and/or a system with artificial intelligence (using health records or other data) to control or change dosages dispensed from a pod to a higher or lower dosage without having to reorder a prescription, and this is envisioned for use with a pod with a number of the chambers having various or different supplement compositions, some of the serving chambers having different dosages from other chambers (e.g. some chambers with 5 mg doses and other chambers have 2 mg doses), and the like. In further examples, the pod, the dispenser, and the unique identifier may be modified to dispense a newly programmed or determined dosage using a single chamber or multiple chambers only in response to a user, caregiver, or another having acknowledged and approved the change in the dosage. In one non-limiting example, after the health care professional has changed the dosage of a prescription or supplement (e.g. from 5 mg to 12 mg), the dispenser would then dispense two chambers having 5 mg of prescription therein, and one chamber having 2 mg of prescription therein to provide a total dosage dispensed of 12 mg. This, of course, is but one example of many possibilities afforded by the use of unique identifiers and chambers.

In further non-limiting examples, each unique identifier may include one or more of the following information programmed, applied to, coded onto, stored in memory for, or printed on to be added or to communicate to, scanned, read, transferred or viewed to a user or dispenser, apparatus, or the like: (a) Position number of serving chamber 22, (b) Total number of serving chambers 22 per pod, (c) Individual ingredients, (d) Adult or child restrictions, (e) Pharmacy location, (f) Doctor or other medical professional contact information, (g) Allergy information for user and/or other users, (h) DNA information, (i) Personal information such as a full name, birthday, sex, social security number, address or other contact information, etc. for the person who will be consuming contents, and information may include information that is conventionally known as personally identifiable information, (j) A code that activates only validated Pods, such that no approved third-party can counterfeit or otherwise provide invalidated Pods, and where unique identifiers or other programmed information may be used or activated with the validated machines, appliances, apparatuses or portable devices, or augmented or virtual systems etc., (k) Passcode/password protected, (l) Weight of individual ingredients, (m) Percent composition of each individual ingredient, (n) Total composition of the serving chamber 22, (o) Flavor ingredients, (p) Effervescent ingredients, (q) The supplement compositions, (r) Supplement compositions contents, (s) Liquid amount for the dose, (t) Mixing time required, (u) Vibration time required, (v) Lot code, COA, country of origin, etc., (w) User's personal identification or biometric features, such as a finger blood prick, finger temperature reading, thermal camera body scan for temperature reading, facial recognition, retina identification, fingerprint identification, voice recognition, or the like, (x) Reminder times, and/or (y) Prescription or supplement instructions, e.g. time of day, with or without a meal, etc.

This unique identifier may be inputted and associated to a pod 20 at the time of assembly or time of filling through any of various well-known means that include, but are not limited to, a separate plastic cap or top, sticker, ink, laser, QR code, code, barcode, RFID, codex, script, electrical strip, etc. This unique identifier can be read by a user or by a dispenser through a QR code reader, a code reader, a barcode reader, an RFID reader, a codex reader, a script reader, an electrical code reader, natural language (i.e., written words), etc. The unique identifier can be affixed to any suitable surface of the serving chamber 22 or embedded therein (as in the case of RFID and the like).

The unique identifier may be used with an extended reality, mixed reality virtual reality or augmented reality viewing devices to view information programmed onto the unique identifier. As such, the dispensing machine and/or viewing devices reads the identifier code, and the viewing device projects information, details, data, videos, video conferencing, telehealth, or the like and projects the information for the user of the viewing device. For a dispensing apparatus that reads the identifier, the dispensing apparatus communicates, e.g. wirelessly, with the viewing device, and the viewing device may additionally access information stored in the cloud and/or memory for the dispensing apparatus.

Furthermore, the unique identifier may read by a mobile device, wearable device, desktop or countertop device or the like to view information on such device that is associated with the unique identifier.

The dispensing apparatus may be further provided with one or more sensors in communication with the apparatus controller. The sensors may include one or more cameras, microphones, and/or other sensors known in the art and configured to use facial recognition, speech recognition, eye retina recognition, fingerprint recognition, saliva recognition, body hair recognition, personal implement unique identifier, or the like to read personal information to verify the user prior to dispensing or to confirm that a dose has been consumed.

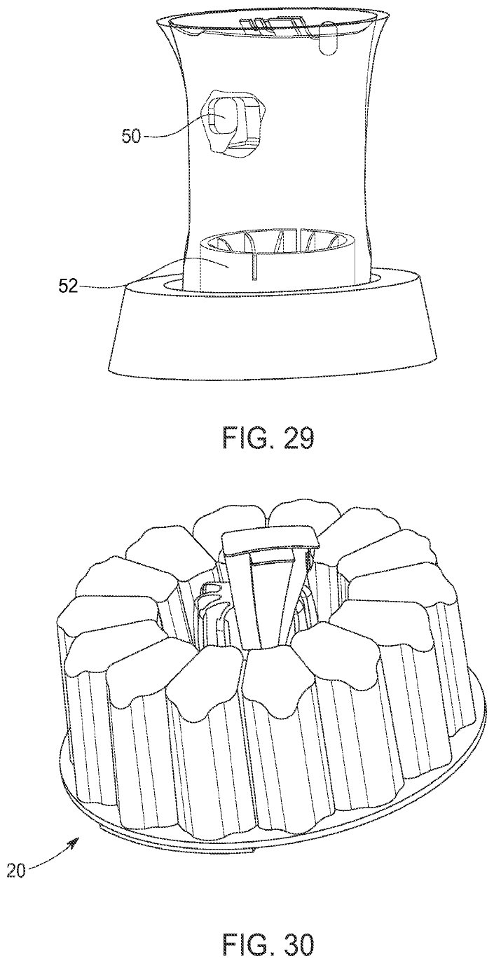

Furthermore, the dispensing apparatus may be further provided with one or more sensors in communication with the apparatus controller to determine that a dose has been fully consumed by the user. For example, a cup sensing camera, infrared lens, cup sensing weight scale, or the like may be used to determine that the dispensed dose has been consumed based on a change in the weight of the cup or the level in the cup between when the dose is dispensed, and when the dispensing cup is returned to the apparatus. A non-limiting example of a dispensing apparatus is shown in FIG. 29, which is a photographic view of a dispensing apparatus according to the present disclosure with a sensor 50, as well as a scale 52 associated with the cup bay. The apparatus in FIG. 29 may include sensing for detecting when a user removes a cup or for when supplement or the cup is removed from the cup bay or tray via the sensor, detecting the weight of cup to know if the supplement has been consumed, and a camera or other sensor to verify the identity of the user, to verify that a supplement has been consumed, to thermally sense or detect the user's temperature, or the like. The sensor may detect a user's presence or to detect if the user swallowed the dosage, for example, using a microphone, a camera, or another remote sensor. There may be other sensors in the home, the office or care facility to sense the user's movement, and proximity.

A portable dispensing apparatus may additionally have one or more sensors to read or interface with the unique identifier, and monitor usage while a user is away from a stationery or countertop dispensing apparatus. The portable dispensing apparatus may include a power source such as a battery, and the battery may be rechargeable.

The portable dispensing apparatus may be removably mounted or otherwise supported by a countertop apparatus, wall-mounted apparatus, car mounted apparatus, mobile cart system, stationary system, and/or a system with removable and disposable cups or containers for the dispensing and tracking from various locations based on the user(s) daily routine to dispense supplements.

The unique identifier may be provided with or integrate with blockchain. Blockchain allows for information associated with the unique identifier to be secure and private based on ability for encryption and decentralization, and also allows for secure tracking of the pod through the supply and consumption chain from inception to consumption, shared securely.

The unique identifier may be used by artificial intelligence (AI) methods or another algorithm that are provided on the dispensing apparatus, or on a remote server or device in communication for various purposes. For example, automatic ordering and reordering of supplements may be determined and automated, which may be of use for pharmaceutical prescriptions using various inputs such as usages, dosage time of day user information, inputs from a medical professional, and the like. Similarly, the unique identifier may be used with an AI method or other algorithm to change, modify, expand, predict, learn, and/or improve (including in real time) the information of potential health issues or health improvements, and may use information such as health records, sensors, cameras, microphones, wireless frequencies, wearable devices, personal information and the like as additional inputs to provide better outcomes, different treatments, dosages, medication, and more preventive healthcare opportunities to users, as well as manage treatments.

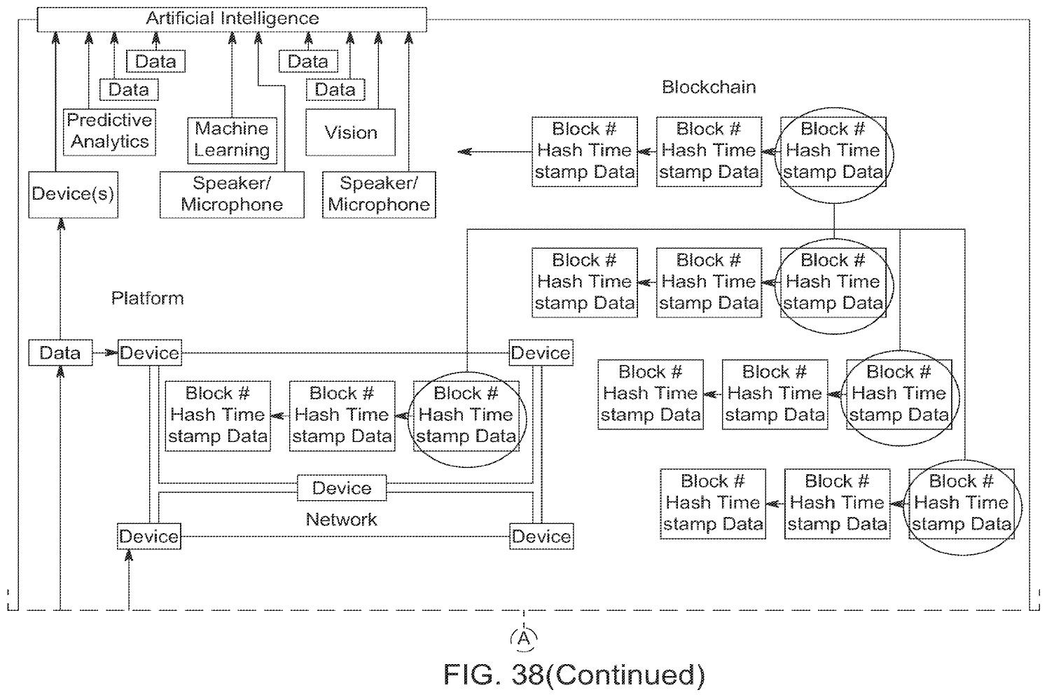

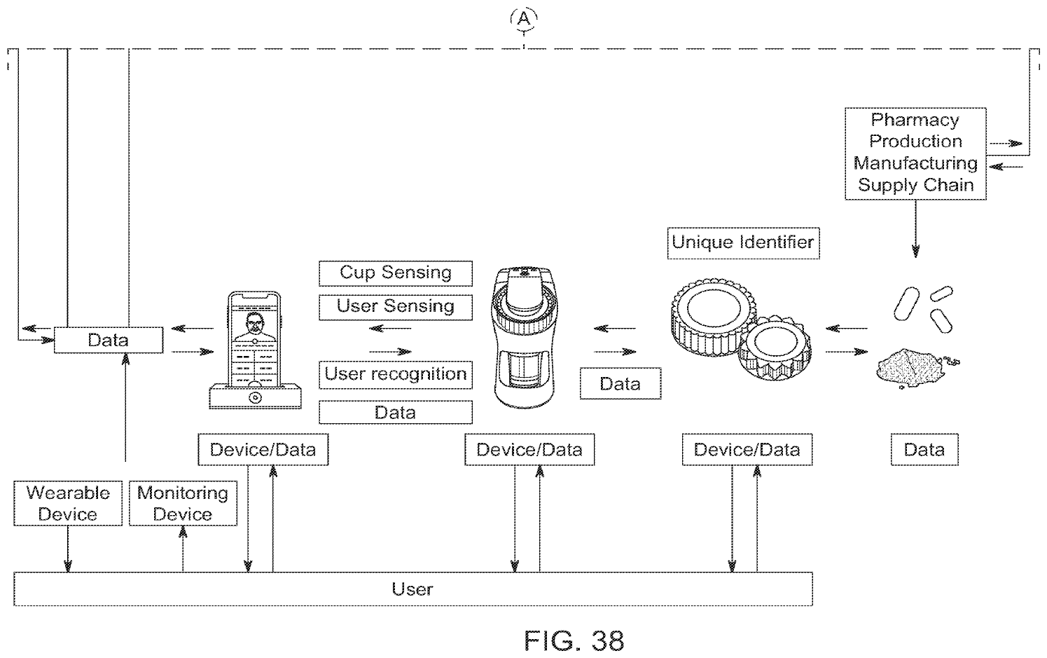

FIG. 38 is a schematic illustrating an example of an integrated system using the dispensing apparatus and/or pod according to the present disclosure. The schematic includes medication management, supply chain management, transmission and protection of personally identifiable information or other information, receiving user(s) data from mobile device(s) wearable device(s) and/or from the dispenser(s) (e.g. as timestamps), providing data to a centralized or remote system, and storing and analyzing data to generate further health analysis, advice, or guidance, or to provide notifications or receive instructions from a user, caregiver, medical/healthcare professional, etc., as well as manage any reordering, refilling, dosage modifications, etc. As shown, the system may use blockchain technology, artificial intelligence, big data, and IoT.

Furthermore, there is a need for each serving chamber 22 to be marked or otherwise identifiable as having been previously emptied if not from a visible marking. The unique identifier may have read-write capability so as to receive a readable signal indicating that the contents have been either evacuated or used, and/or not evacuated or used Prior to each use, then, the dispensing apparatus, machine and/or user can quickly survey the pod 20 to assess how many serving chambers 22 remain un-opened compared to how many serving chambers 22 total started with the multi chamber pod 20.

Thus, the multi-serving pod 20 may have a unique identifier associated and fixed to each individual serving chamber 22. This unique identifier will provide commands to a dispenser apparatus (not shown). These commands will tell the pod 20 how to act when inserted into the dispenser. These commands will tell the dispenser what to do when initiated by the user, how much liquid to add, how long of a mix time, what data or information to display, what data or information to receive/send, etc. The unique identifier can also include security features, such as password protection, child safety features, forgetting usage and locking out for the medication regime for that formula, caregiver lock out features away from the dispenser apparatus, dosing restrictions (e.g., number of times a day to be taken, number of times in a row to be taken, etc.) so that a dispensing machine can assist with the correct administration of the formulas. The dispenser apparatus may be configured to access remote systems via Bluetooth, the internet or cellular network, so that these rules and activity reports can be shared through wireless, wired, or cloud-computing platforms. This will enable users, health care providers and care-givers to assess user's dosing activity in real time.

As shown in several of the Figures, the pod 20 may include a travel cap 34. The cap 34 is another concept component that attaches to the top, i.e., trigger 28 side, of the pod 20. The purpose of the cap 34 is to prevent the inadvertent evacuation of unintended serving chambers 22 for safety and to read the unique identifier of the multi-serving pod 20 chambers. The cap may be configured to access remote systems via Bluetooth, the internet or cellular network, so that these rules and activity reports can be shared through wireless, wired, or cloud-computing platforms. The cap 34 has a small window 36 that has about the same radial width as a single serving chamber 22 so as to expose a single trigger 28, as shown for example in FIG. 6.

The cap 34 is designed with a sliding fit to the top of the pod 20. When the cap 34 is rotated relative to the pod 20, each trigger 28 transits the window 36 one at a time. By aligning the window 36 over the trigger 28 of the intended serving chamber 22, the user or a dispenser apparatus is able to evacuate only that one serving chamber 22 and no others and may read/write the unique identifier/data into the cloud.

In the absence of a cap 34, the pod 20 may alternatively be fitted with a suitable locking/child safety feature to prevent more than one serving chamber 22 from being opened at once. For example, the alternative locking/child safety feature could be located in the center of the pod 20, and mechanized to require a two-step activation method to prevent user from opening any serving chambers 22 without it being on purpose. Such a feature would have the added benefit of preventing children from accessing the contents of serving chambers 22 without permission. Such a feature would trigger an action or notification to any user, medical/healthcare professional or caregiver.

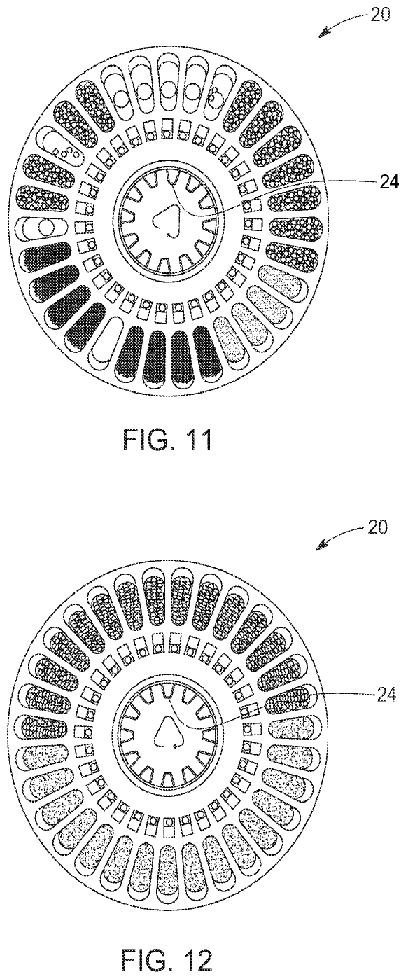

Because of its ability to prevent cross-contamination caused by residues from previously opened serving chambers 22, the pod 20 is particularly well-suited to containing different supplement compositions and/or different supplement quantities in different serving chambers 22 of the same pod 20. This is referred to as serving-to-serving variability. The example given previously was of a higher concentration dose administered for daytime consumption and a lower concentration dose for nighttime consumption. However, this same feature also benefits the situation where it is desirable to segregate certain components that may be ill-suited for long-term comingled storage but that nevertheless are intended for concurrent consumption in a single dose. For one example, if a dose is composed of Part A Supplements and Part B Supplements, however Part B Supplements will cause clumping, degradation of ingredients, collect moisture or spoil the serving in Part A when stored together, or otherwise provoke some other adverse interaction, then Part A Supplements can be contained in separate serving chambers 22 from the Part B Supplements, such as illustrated in FIGS. 11 and 12. At the time of dispensing, a serving chamber 22 containing a Part A Supplements will be first evacuated into a mixing cup (not shown), and immediately thereafter the Part B Supplements is evacuated into the same mixing sup so that both Parts A and B are consumed in the same dose.

This same strategy can be applied when a single serving chamber 22 does not have the volumetric capacity needed for a complete dose. For example, if a dose requires 1000 mg of a supplement, but the capacity of the serving chamber is less than 1000 mg, the dose can be spread across any two or more serving chambers 22 whose combined total supplements volume is at least 1000 mg. Moreover, if used in conjunction with a dispenser apparatus or cup that is configured to access the internet, and furthermore the administrator or an authorized health care provider is able to modify the rules/programming of the dispenser apparatus as pertains to the pod 20, the medical/healthcare professional or a system using artificial intelligence could alter, in real time, and in a secure, recorded manner with consent, each dose based on their professional opinions for the user. For example, the dispensing machine could be controlled so as not to administer Part B for any given dosing. Or perhaps the quantity of a particular supplement could be increased or decreased based on the judgement of the health care provider.

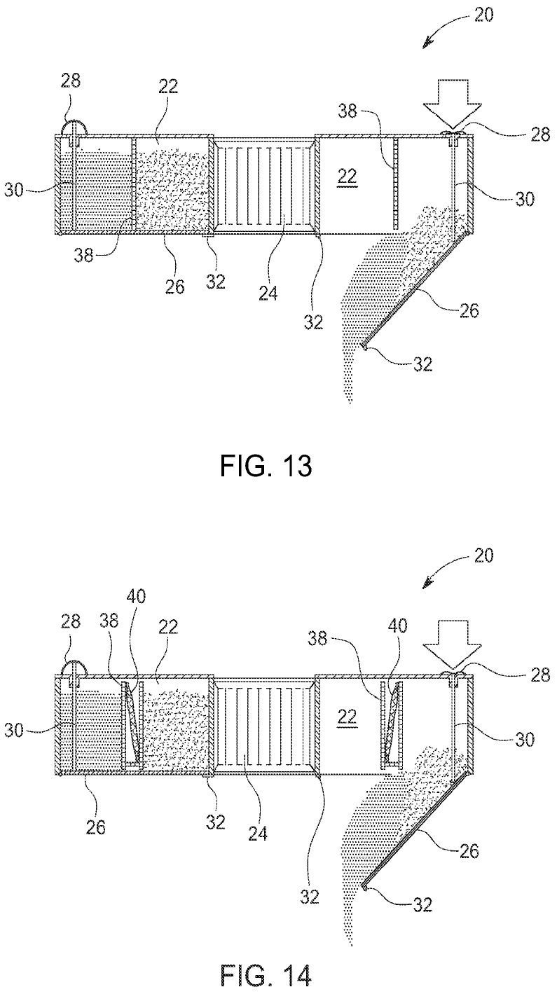

Alternatively, the serving chamber 22 can itself be segregated with a partition 38, as shown in FIG. 13. The partition 38 can be used to maintain physical separation between the Part A and Part B ingredients (continuing the previous example). As illustrated in the highly simplified FIG. 13, Parts A and B are maintained separate until the trap door 26 is opened, at which time Parts A and B are simultaneously evacuated, or are evacuated sequentially or at different selected times. FIG. 24 shows yet another variation in which each partitioned serving chamber 22 is fitted with separately-controllable trap doors 26. The separate compartments in the split serving chamber 22 could, for example, both contain Part A in order to have 2 times more servings per pod 22 than are serving chambers. In this example, the trap door 26 is split to be opened from two (or more) different rods 30 in the same serving chamber 22 but with two (or more) independently evacuate-able sub-chambers. Those of skill in the art will appreciate the many possibilities opened by these types of arrangements.

FIG. 14 shows a further extension of the partition 38 concept, wherein ingredient Parts A and B can be segregated, together with the inclusion of a desiccant packet 40 to help sustain a state of dryness within the serving chamber 22. In this case, the partitions 38 are configured to retain the desiccant packet 40 inside the serving chamber 22 so that it does not evacuate with the supplements. Many variations of a dedicated desiccant pack pocket within each serving chamber 22 are of course possible.

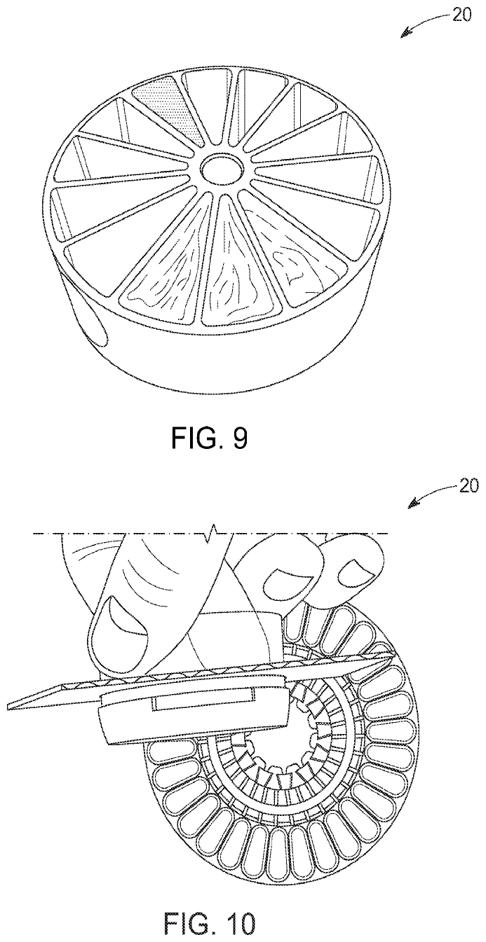

FIG. 8 illustrates a pod with different trap door arrangements. FIG. 9 illustrates a pod containing a liquid supplement within the serving chambers. FIG. 10 illustrates an exploded view of a pod according to an embodiment.

FIGS. 15 and 16 show a still further contemplated variation of this novel pod 20, in which the serving chambers 22 are separable from the pod 20. Each serving chamber 22 in this example is a self-contained unit that can be separated assembled with the other serving chambers 22 to form the ring-shaped pod 20. The drive hub 24 can serve as the common connector, and/or, the serving chambers 22 are designed to interlock with one another. One advantage of this design is understood within the context of manufacturing. When the pod 20 is intended to have each serving-to-serving variability, the manufacturer can more easily mass-produce and store serving chambers 22 having specified supplement contents. Then for the custom needs of a particular user, the pod 20 can be assembled by selecting “off the shelf” specific serving chambers 22 from inventory. In this manner, a user or the care giver of a user can conveniently customize a pod 20 to suit the need. Sealed individual serving chambers 22 could even be shipped on demand to locations where doctors can easily interchange serving chambers 22 to customize pods 20 for their patients during one-on-one visits, similar to eye doctors providing individually packaged soft contact lenses.

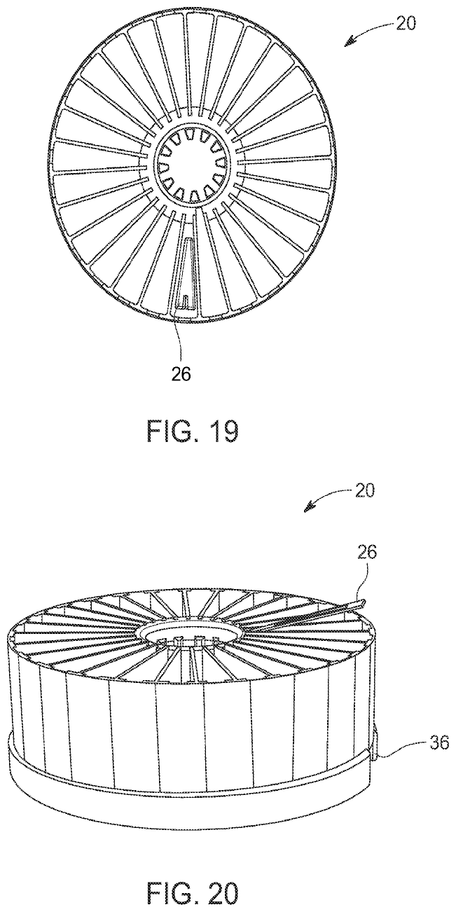

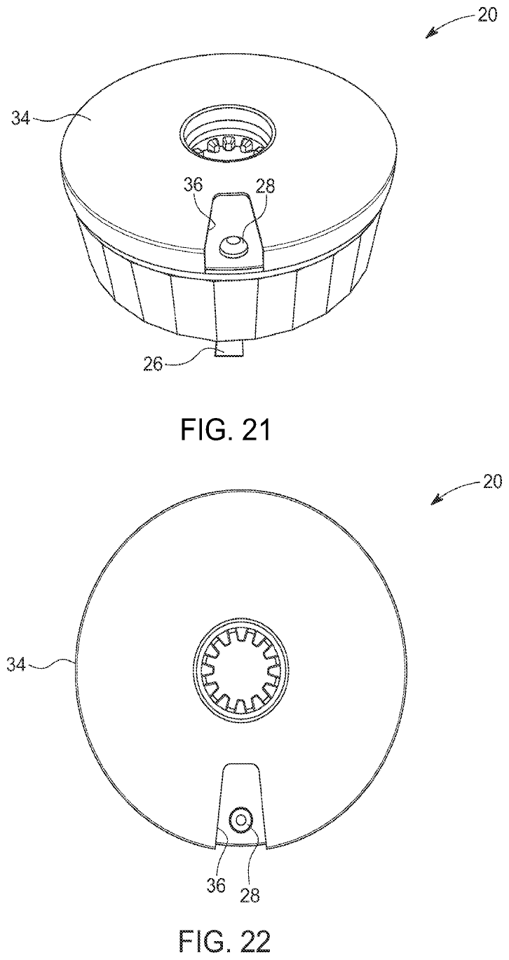

The trap door 26 can be hinged from the front, back, left or right, or openable by some other means (e.g., like a poppet valve). FIGS. 17-22 depict variations in which the trap door 26 is hinged from its radially inward end (i.e., adjacent the hub 24). FIG. 23 shows a variation in which the trap door 26 is hinged along one radial edge. FIG. 24 shows a variation in which each serving chamber 22 is subdivided with a partition 30, with separately-actuatable trap doors 26 associated with each sub-chamber. These illustrations are intended to provide basic, representative examples of the many different configurations possible within the spirit and scope of this invention.

Thus, it will be appreciated that for a health care provider, a single pod 20 with various supplement compositions inside sealed serving chambers 22 can be programmed by the health care provider, pharmacist or through artificial intelligence based on user data, other users data, demographics and current health conditions and other information. Furthermore, this invention enables the pod 20 to be programmed to suit an individual user's selection. A user will provide information describing their current health conditions, the user will provide additional information. This information combined will provide a user with a custom-designed pod 20 according to their current health condition. The user will be able to add and remove individual ingredients to their pod 20 to achieve a custom blend of supplement doses.

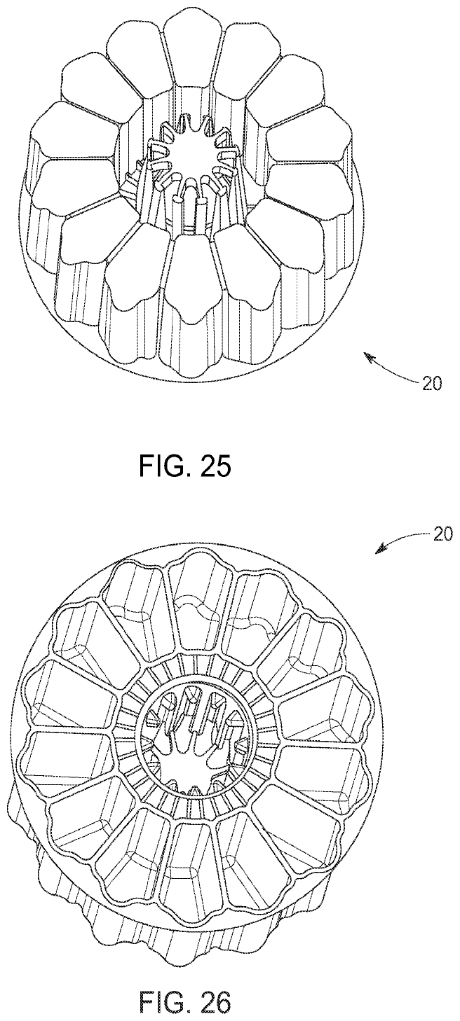

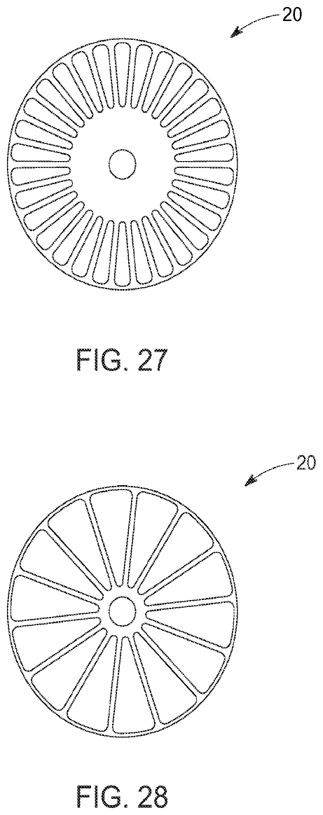

FIGS. 25-26 illustrate another pod 20 according to the present disclosure. FIGS. 27-28 illustrate pods according to the present disclosure with different numbers of chambers. The pods 20 in FIGS. 25-28 may be configured for use with a trap door(s), with foil, or with another closure member to enclose one or more of the chambers.

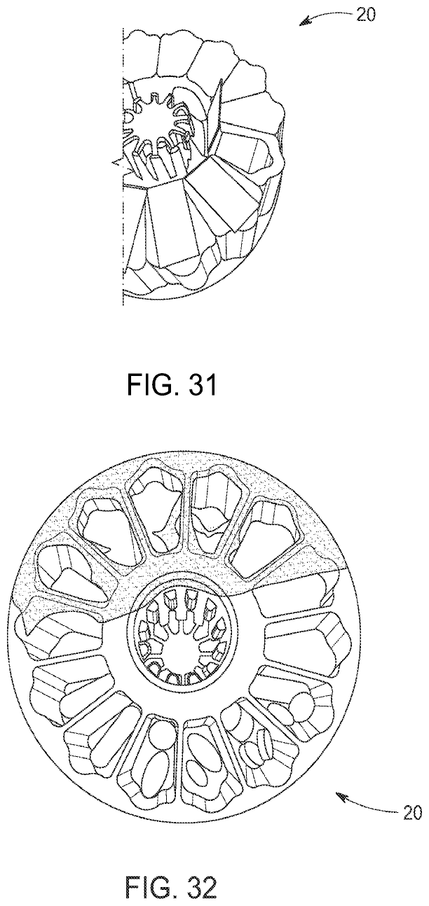

FIGS. 30-31 illustrates other pods 20 according to the present disclosure with a trap door on one of the chambers. In further examples, each of the chambers may be provided with an associated trap door or multiple trap doors per chamber, e.g. on the top, bottom, and/or along the outer band/circumference. The pods 20 may be provided with trapdoors for each chamber on a first side or face or the pod, on a second side or face of the pod, or on both sides or faces of the pod. The trap doors may be used to dispense supplement, or alternatively may be used for filling or refilling chambers with supplement via a machine, a medical professional, the user, or another person. Although sticker or membrane elements are shown in FIG. 31, trap doors are also contemplated. In further examples, the pod may be provided with foil, film or membrane cover on one or both faces to seal the chambers.

FIG. 32 illustrates a pod 20 with different supplements in different chambers, and with multiple supplements in each chamber. Although the pod is shown with a partial foil, film or membrane cover, trap doors are also contemplated.

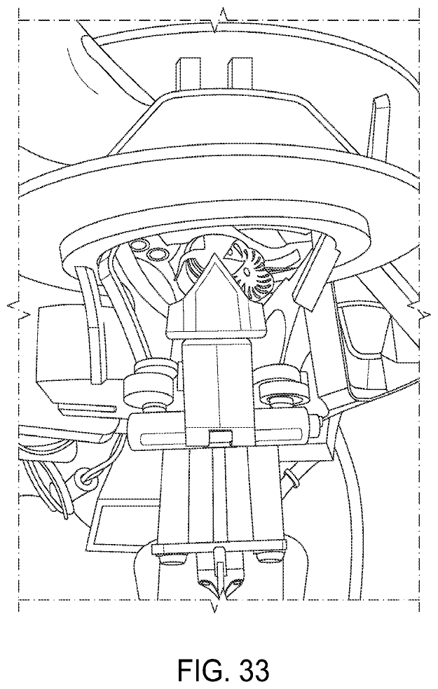

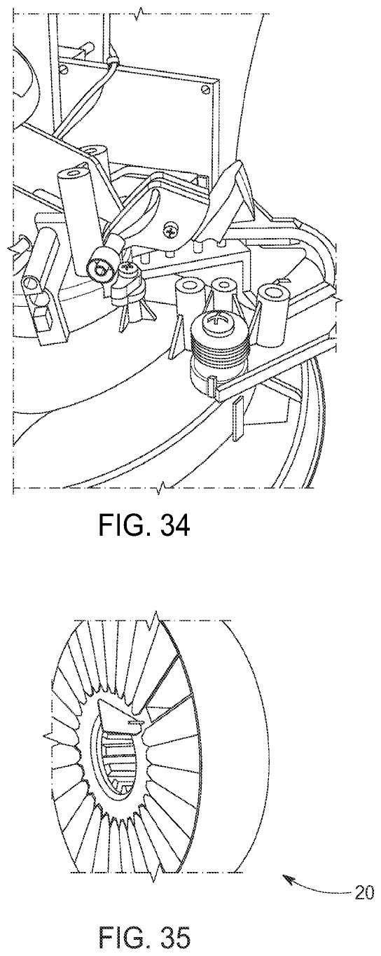

FIGS. 33-34 illustrate an opening mechanism for use with a dispensing apparatus and pod according to the present disclosure. The opening mechanism is hinged or otherwise rotatably connected to the apparatus. The opening mechanism as illustrated may be used to pierce or otherwise open a foil, film, or membrane covered chamber of a pod. The protrusion that pierces the membrane may extend into the chamber or cell to assist in removal of supplement therefrom. The protrusion may additionally be similar shaped and/or sized as the chamber or cell. Alternatively, the foil piercing mechanism as illustrated may include a latching member or other portion to connect to or otherwise move a trap door covering a chamber to open the trap door to dispense supplement and/or close the trapdoor after the supplement has been dispensed. For example, the latching member may connect to the trap door via a latch or interfacing lips, a magnet, or the like.

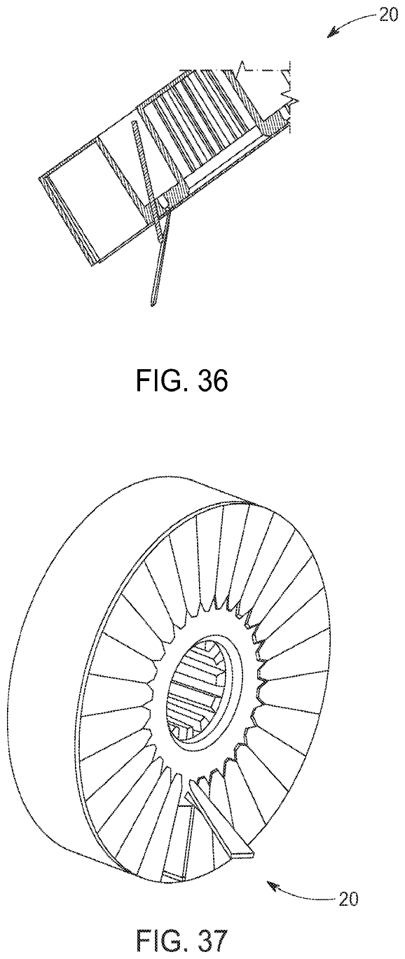

FIGS. 35-37 illustrate a pod 20 according to the present disclosure with a pin or the like to open the trap door and dispense supplement from a chamber, or otherwise open the chamber, e.g. for filling or refilling. The pin may be formed as a part of the pod, or may be provided in the dispensing apparatus (countertop or portable), and extend through the pod to open the trap door.

Various embodiments according to the present disclosure therefore provide for a pod and dispensing apparatus that are able to dispense pills as well as other supplements in various forms. The dispensing apparatus, pod, and associated controllers communicate with remote systems, computers, and/or personnel to provide compliance, data tracking and collection, and supplement management. This may be further enabled via use of unique identifiers, as well as internet-of-things (IoT) devices, as well as augmented or virtual reality systems. This may also provide for integrated or automated ordering, re-ordering, prescription filling, dosage modifications, and the like. The dispensing system may provide outputs to a user, or to a remote device of a user such as a mobile device, wearable device, hardware device, etc. to provide reminders, health information, dosage information, etc. related to when to take a supplement, or other notifications.

While exemplary embodiments are described above, it is not intended that these embodiments describe all possible forms of the invention and disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

1. A multi-serving cartridge assembly comprising:
a frame having sidewalls extending axially to define a plurality of serving chambers arranged in an annular array centered about a central axis, the frame having a first side defining a plurality of chamber openings, each chamber opening associated with a respective one of the serving chambers, the frame having a second closed side opposite to the first side, each serving chamber sized to receive a supplement;
a drive hub supported by the frame, the drive hub to interface with a drive mechanism of a dispensing apparatus; and
a plurality of trap doors, each trap door associated with a respective one of the plurality of serving chambers, each trap door connected to the frame for movement relative thereto between a first closed position to enclose the associated serving chamber and a second open position to dispense the supplement therefrom, wherein each trap door is separably openable.

2. The assembly of claim 1 wherein each trap door is connected to the first side of the frame via a hinge for rotation relative to the frame.

3. (canceled)

4. The assembly of claim 1 wherein each trap door is connected for translation relative to the frame such that each trap door slides between the first position and the second position.

5. (canceled)

6. The assembly of claim 1 further comprising a plurality of push rods, each push rod extending axially across a respective one of the serving chambers, each push rod abutting the associated trap door such that movement of the push rod moves the associated trap door; and
wherein the second side of the frame defines a plurality of convex triggers, each convex trigger associated with a respective one of the serving chambers and engageable with a respective one the convex triggers, wherein depressing one of the convex triggers moves the associated push rod to open the associated trap door.

7. (canceled)

8. The assembly of claim 7 further comprising a cap sized to extend over and cover the second side of the frame, wherein the cap is removably connected to the frame for rotation relative thereto, the cap defining a window sized to expose a selected one of the convex triggers; and
a plurality of unique identifiers, each unique identifier associated with a respective one of the serving chambers to provide information related thereto;
wherein the cap further comprises a controller in communication with a sensor to read the unique identifiers, and a wireless transmitter to send a signal indicative of the information provided by the unique identifiers.

9. (canceled)

10. (canceled)

11. The assembly of claim 1 wherein each trap door has a funnel-like shape on an inner face to direct supplement within the associated serving chamber.

12. The assembly of claim 1 further comprising a plurality of second trap doors, each second trap door associated with a respective one of the plurality of serving chambers, each second trap door connected to the frame for movement relative thereto between a first closed position and a second open position, wherein each second trap door is separably openable.

13. (canceled)

14. The assembly of claim 1 further comprising a plurality of partitions, each partition extending across an associated serving chamber to divide the associated serving chamber into a first and second sub-chambers and separate supplement received therein.

15. (canceled)

16. The assembly of claim 1 further comprising a unique identifier, each unique identifier associated with a respective one of the serving chambers to identify and provide information regarding each serving chamber.

17. A dispensing system comprising:
a housing, the housing including a cartridge bay shaped to receive a generally annular cartridge for rotation about a central axis, the generally annular cartridge centered about the central axis and including a plurality of serving chambers to receive supplement in each serving chamber and a plurality of unique identifiers, each unique identifier associated with a respective one of the serving chambers to identify and provide information regarding each serving chamber;
an actuator system supported by the housing, the actuator system having a member to engage the cartridge to selectively open one of the serving chambers and empty the supplement therefrom;
a cartridge drive mechanism for rotating the cartridge about the central axis within the cartridge bay, wherein the cartridge drive mechanism comprises a motor to engage and rotate the cartridge when the cartridge is disposed in the cartridge bay;
a sensor supported by the housing adjacent to the cartridge bay, the sensor positioned to read one of the unique identifiers; and
a computer control system operatively connected to the cartridge drive mechanism to (i) rotationally index the cartridge in the cartridge bay until an unopened serving chamber is located directly adjacent the actuator system, (ii) read the unique identifier associated with the unopened serving chamber, (iii) control the member to open the serving chamber, and (iv) send a signal to a remote system with the information regarding the associated serving chamber.

18. The dispensing system of claim 17 wherein the cartridge has a plurality of trap doors, each trap door associated with a respective one of the plurality of serving chambers and moveable between a first closed position enclosing the associated serving chamber and a second open position to dispense supplement; and
wherein the member of the actuator system engages and moves the trap doors one at a time to selectively open one of the serving chambers and empty the supplement therefrom.

19. The dispensing system of claim 17 further comprising another sensor supported by the housing and in communication with the computer control system;
wherein the another sensor is configured to read personal identification information associated with a user, and wherein the computer control system verifies the user based on the personal identification information.

20. The dispensing system of claim 19 wherein the personal identification information is at least one of a finger blood prick, a finger temperature reading, a thermal camera body scan for temperature reading, a voice recognition, a facial recognition, a retina identification, and a fingerprint identification.

21. The dispensing system of claim 17 wherein the information provided by each unique identifier includes at least one of a type of a supplement, a shape of a supplement, a color of a supplement, a size of a supplement, a label for the supplement, a chemical composition of the supplement, instructions for consumption of the supplement, and instructions for dosing of a supplement.

22. The dispensing system of claim 17 further comprising another sensor associated with a dispensing platform of the housing, the another sensor being one of a camera, an infrared camera, a microphone, and a scale;
wherein the computer control system is configured to receive a signal from the another sensor to determine that a dispensed supplement has been consumed by a user.

23. The dispensing system of claim 17 wherein the remote system is a remote viewing device, and wherein the computer control system is configured to send a signal to the remote viewing device to overlay the information from the unique identifier as part of a virtual reality or an augmented reality.

24. The dispensing system of claim 17 wherein the computer control system is configured to receive an updated dosing schedule from the remote system based on the unique identifier, and at least one of an input from a medical professional, a health record, personal information of a user.

25. The dispensing system of claim 17 wherein the unique identifier includes a block of blockchain.

26. A method of dispensing supplement from a cartridge, the method comprising:
sensing a unique identifier associated with a serving chamber of a cartridge that provides information regarding supplement within the serving chamber, the cartridge having a plurality of serving chambers to receive a volume of supplement in each serving chamber and a plurality of unique identifiers;
verifying a user based on sensed personal identification information associated with a user of the cartridge;
sending a signal to a remote viewing device to overlay the information from the unique identifier as part of a virtual reality or an augmented reality;
sending another signal to a remote system with the information from the unique identifier;
receiving information from the remote system with updated dosing information for a user determined as a function of the unique identifier, and at least one of an input from a medical professional, a health record, and personal information of a user;
dispensing supplement from the cartridge by opening one or more of the serving chambers based on the updated dosing information via an actuator system with a member to engage the cartridge to selectively open one of the serving chambers; and
sensing that a dispensed supplement has been consumed by a user.

27. The method of claim 26 wherein the unique identifier contains a block of blockchain.
